(19) United States
(12) Patent Application Publication
(10) Pub. No.: US 2013/0256255 A1
(43) Pub. Date: Oct. 3, 2013

(54) STACKABLE SPILL RESISTANT CONTAINER

(71) Applicant: Susan Van Volkenburg, Boca Raton, FL (US)

(72) Inventor: Susan Van Volkenburg, Boca Raton, FL (US)

(21) Appl. No.: 13/853,959

(22) Filed: Mar. 29, 2013

Related U.S. Application Data
(60) Provisional application No. 61/617,715, filed on Mar. 30, 2012.

(51) Int. Cl. A61J 9/00; B65D 21/02; A47G 19/22

(52) U.S. Cl. CPC A61J 9/00; A47G 19/2255; B65D 21/0233
USPC 215/11.1; 220/625; 206/517

(57) ABSTRACT

A spill-resistant container has a low center of gravity and a wide base to increase its stability and prevent being overturned. The container has a wide bottom, a top less wide than the bottom and ribs, channels and/or coating to facilitate gripping of the container. The base of the container has a removably attachable and bottom to facilitate stacking and cleaning of the containers. The neck region and body design of the container allows stacking of the containers when stored.

### CROSS-REFERENCE TO RELATED APPLICATIONS

This application claims priority to U.S. Provisional Application Ser. No. 61/617,715, filed Mar. 30, 2012, the contents of which are hereby incorporated in its entirety.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

1. Field of Endeavor

The present invention relates to containers resistant to spilling or being overturned. More particularly, the invention relates to a vessel having a wide base, a low center of gravity, along with a gripping feature, and has a removable bottom allowing for easier cleaning and storage in a stackable nesting fashion when not in use.

2. Background Information

Use of special containers for children designed to train them to drink from a container instead of a baby bottle are in common use today. Known as “sippy” containers, there are many varieties available. However, the use of sippy containers has become controversial because those that are spill-proof typically have a valve feature that requires the child to suck in order to obtain a drink. Not only do these containers not teach a child how to drink from a container, this can lead to the habit of the child's sucking the container's mouthpiece while lying down, as if it were a baby bottle. In addition, it is thought that these containers may lead to poor oral hygiene and other undesirable affects.

A child's first teeth, which are deciduous and often called “baby teeth” are important to both the child's health and to his future permanent teeth. As a baby or young child, tooth decay can cause inability to chew food, speech impediments and cause a child to have an unattractive smile. Deciduous teeth hold space in the jaw for the permanent teeth as well. If a deciduous tooth is lost prematurely neighboring teeth can drift into the empty space. This can cause crooked and crowded permanent teeth requiring orthodontics and other adult tooth problems.

The most common areas for decay are the upper four front teeth. Baby bottle tooth decay occurs when a baby lies down with a bottle that is filled with a liquid such as milk, formula, fruit juice, or a sweet liquid like soda pop or a sugary drink. When these liquids stay on the teeth for extended periods of time, the sugar and bacteria contained therein start to decay the teeth. Warnings about baby bottle tooth decay extend to small children using spill-proof training (“sippy”) containers. Many childhood experts, including the American Dental Association, state that children should start drinking from a container at about the age of one year, and advise only temporary use of training containers because of the possibility of prolonged contact with deciduous teeth and sugary liquids, as has just been described.

Standard containers are typically made with a small base and a larger opening from which to drink. This is largely in part due to manufacturing; it is easier to remove a so shaped container from a mold. A container with this shape is frequently tipped over accidentally by children. Small children also have relatively poor motor skills and may also have difficulty firmly grasping a container and often drop items they are holding. Young kids also spill drinks with the use of a standard container by dribbling the liquid out of the corners of their mouth because the opening in the top of the container is too large and liquid overflows their mouth, causing a spill down the front of their shirt or dress. A standard container also leads to splashes out of the top of the container as a child carries a drink around the house. This leads to further frustration for parents with the need for the floor or carpet to be cleaned. Thus, if a child is not to use a “sippy” container, then he/she is likely to spill drinks frequently, causing extra work and aggravation for his or her parents and other caregivers.

Other sectors of the population that may have problems with spilled drinks are beer drinkers who are drinking their beer from a tap or keg and using a typical plastic disposable container. These containers also have a large opening in the top and a small base making them inherently unstable. Drinks are frequently spilled while at stadiums or parties. Boating enthusiasts are also in need of a stable container that can better handle turbulence at sea and can also provide space savings with a stacking feature.

While wide base stable containers exist, as one sees most frequently as a coffee mug, or a thermo mug as documented by Allen, et al in U.S. Pat. No. 5,515,995 these containers take up considerable storage space due to their inability to stack. This inability to stack also leads to decreased efficiency during shipping and displaying of goods in the marketplace. And while these containers are more stable and harder to spill, the more narrow top opening also makes it more difficult for someone to get their hand inside the container to clean the inside and bottom of the container.

It is therefore desirable to provide a container that is difficult to spill, easily held firm and can be more effectively and efficiently stored and cleaned.

### BRIEF SUMMARY OF THE INVENTION

Accordingly, the primary object of the present invention is to provide a spill-resistant container having a low center of gravity and a wide base to increase the difficulty with which the center of gravity is sufficiently displaced such that the container spills over.

The container comprises a body that includes a neck region, an open top, an open base, and a removably attachable bottom. The body has a cross sectional dimension opening at the base that is wider than the cross sectional dimension opening at the top. The body of the container may be substantially frustoconical or truncated cone shaped. Multiple container bodies are therefore stackable in a nesting position when the bottoms are not in place. The “container” does not effectively become a container until the bottom is in place and it will not hold liquid without the bottom in place.

The body of the container also has a neck region. The neck region may be cylindrical. The neck region may include a gripping means, such as one or more ribs, one or more channels and/or one or more coatings of material to enhance the gripping means. The top opening in the container may extend outward so that it is wider than the neck region. The removable bottom of the container may include an annular flange to assist with removing bottom or further enhance stability. The removable bottoms may stackable as well. The removable bottom of the container may have a handle attached that will not interfere with the stacking.

It is therefore an object of the present invention to provide a container that resists spilling.

It is a further object of the present invention to provide a container that resists spilling, is easily held, easily cleaned and stacked.

These and other objects and advantages of the present invention will become apparent from a reading of the attached specification and appended claims. There has thus been outlined, rather broadly, the more important features of the invention in order that the detailed description thereof that follows may be better understood, and in order that the present contribution to the art may be better appreciated. There are features of the invention that will be described hereinafter and which will form the subject matter of the claims appended hereto.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a perspective view of a container in accordance with the principles of the invention;

FIG. 2 is another perspective view of a container in accordance with the principles of the invention;

FIG. 3 is a cross-sectional view of a series of nested containers in accordance with the principles of the invention;

FIG. 4 is a cross-sectional view of series of nested bases in accordance with the principles of the invention;

FIG. 5a is a perspective view of an alternative embodiment of a container in accordance with the principles of the invention;

FIG. 5b is a side view of an alternative embodiment of a container in accordance with the principles of the invention;

FIG. 5c is a side view of an alternative embodiment of a container in accordance with the principles of the invention;

FIG. 5d is a side view of an alternative embodiment of a container in accordance with the principles of the invention;

FIG. 5e is a cross-sectional view of an alternative embodiment of a container in accordance with the principles of the invention;

FIG. 5f is an enlarged cross-sectional view of the bottom of the container and the base of FIG. 5e in accordance with the principles of the invention;

FIG. 6 is an exploded view of an alternative embodiment of a container in accordance with the principles of the invention.

### DETAILED DESCRIPTION

Before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

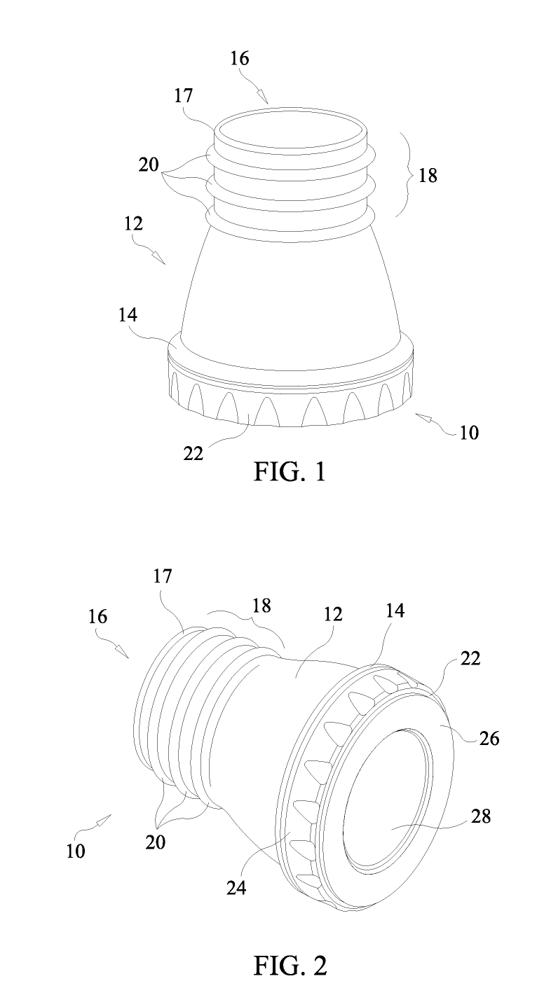

FIGS. 1 and 2 show a container 10 having a body 12 with a bottom 14 wider than its top 16. Container 10 may be comprised of plastic, paper or other materials which are commonly used to fabricate disposable containers. Alternatively, container 10 may be comprised of one or more materials used for nondisposable containers such as plastics, wood, metal, composite materials, glass or any other desired material from which drinking vessels may be constructed. In this embodiment, the body 12 is slightly convex, which may increase the volume in relation to surface area, thus increasing the storage capacity of the container 10. The convex frustoconical shape of the body 12 may also cause the center of gravity of the container 10 to be lower than that of a cylindrical container, thereby increasing the container's 10 stability and reducing the likelihood of tipping over. In this embodiment, the body 12 is convex, but the body may optionally be concave, angular or purely frustoconical without any curvature. Optionally, it may be comprised of a conical prismatic shape, for example having radial symmetry and a transverse cross section of a hexagon, octogon or other polygon or may have an ellipsoid cross-section.

Body 12 also may have a neck region 18 where the body 12 approaches the top 16, and may have one or more annular ribs 20 that may enable more secure grasping of the container 10. The neck region 18 may also include other means for enhance a firm grip on the container 10, such as for example a knurled surface, channels, grooves, coatings of a material that enhances static friction, and/or a rubber coating. These may provide relatively static friction to the neck region 18, thus facilitating firm gripping of the container 10 by an operator. The neck region 18 of the container may be more cylindrical than the rest of the body 12 so as to increase the ease of firmly gripping the container 10 by an operator. Optionally, the neck region 18 may be sloped to a lesser degree, or to an equal degree as the rest of the container 10. The top 16 may include a lip 17 that may comprise a protruding annular ring about the rim of the container 10.

The container may also include a base 22 that may be removably attachable to the bottom 14 of the body 12. Base 22 may be removably attached by threading, a tongue and groove mechanism, friction or other mechanisms that may provide a hermetic seal. In this embodiment, base 22 is screwed on to the bottom 14 of the body 12. The bottom 14 may include an annular flange, as shown in FIGS. 1 and 2. The annular flange and the threading of the bottom 14 and the base 22 may add mass to the outside bottom 14 of the body 12, thereby shifting the center of gravity of the container further downward toward the bottom 14 and the base 22. The mass on the outside perimeter of the bottom 14 and the base 22 may also further inhibit tipping over or spilling of the container 10. Because the base 22 may be removed from the bottom 14, the interior of the container 10 may be more easily cleaned. The removable base 22 may also allow multiple container bodies 12 to be stacked by nesting inside one another.

Base 22 may have a textured outside wall 24 that extends about the periphery of the base 22. The outside wall may have a series of indentations as shown in FIG. 2. Optionally, outside wall 24 may include gripping enhancing features, such as for exampled, it may be knurled, grooved, coated with a material providing static friction, rubberized or otherwise modified to ease removable affixation of the base 22 to the bottom 14. Base 22 may also include a region on the bottom 28, providing increased static friction, such as for example a rubber pad 26. In this embodiment, rubber pad 26 forms and annular ring adjacent to the outside wall 24. Optionally, rubber pad 26 may cover the entire bottom 28 or may comprise a plurality of rubber pads. Alternatively, other materials or structures may be used to reduce horizontal slipping of the container about a surface upon which it is placed. Further, the bottom 28 of the base 22 may include a logo, design or other aesthetic or source indicating feature. Optionally, the base may include one or more handles extending upwardly.

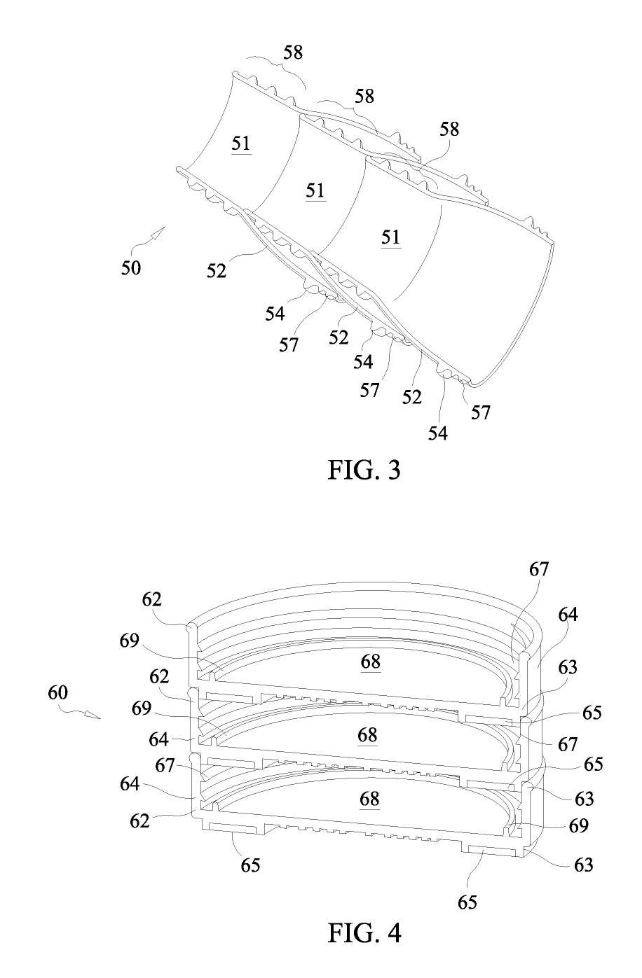

FIG. 3 shows cross section of a series 50 of three nested containers 51, each having a body 52, a neck region 58 and a bottom 54. Threading 57 on each of the bottoms 54 allows removable attachment of a base as shown in FIG. 4 below. The containers 51 have configurations similar to containers 10 of FIGS. 1 and 2. The containers 51 have frustoconical bodies 52 that have wider diameters than neck regions 58. Thus, the neck regions 58 and the bodies 52 are sized such that the neck region 58 may fit within the body 52 or another container 51. This allows the containers 51 to be nested by placing a container's neck region 58 inside the body 52 of another container 51. Multiple containers 51 may be nested, or stacked, in this fashion to consolidate space when storing multiple containers 51. Threading 57 may also be seen at the bottom 54 of each container 51 just below the annular flange located at the bottom 54.

FIG. 4 shows a cross-section of a series 60 of 3 nested bases 62. Bases 62 are similar to the bases 22 of FIGS. 1 and 2. An annular rubber pad 65 may be located on the bottom 68 of each base 62. Threading 67 on the inside of outside walls 64 may facilitate removable attachment to the bottom of a container. Further, lip 69 that may enhance sealing between the base 62 and a container may also be seen. Each of the outside walls 64 may include a small shoulder 63 adjacent to the bottom 68, which may allow nesting of the outside walls 64 of a base 62 with a base placed directly on top of it. Thus, the bases 62 may be stored in a space conserving manner.

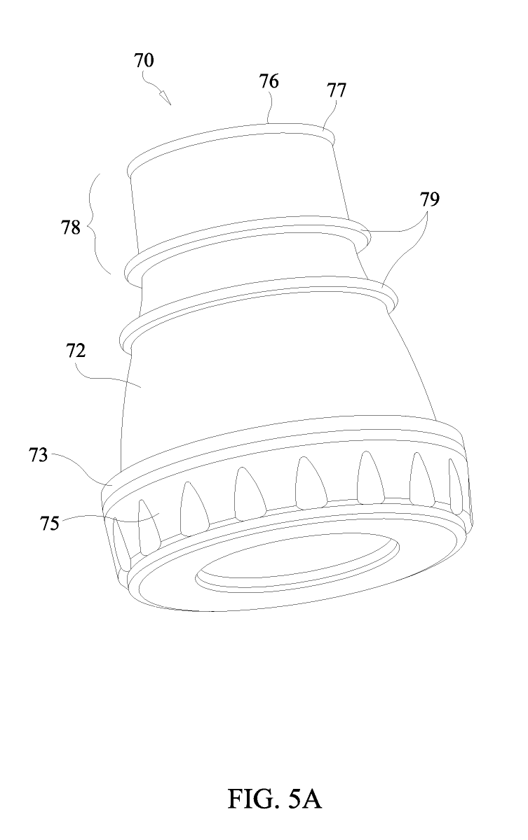

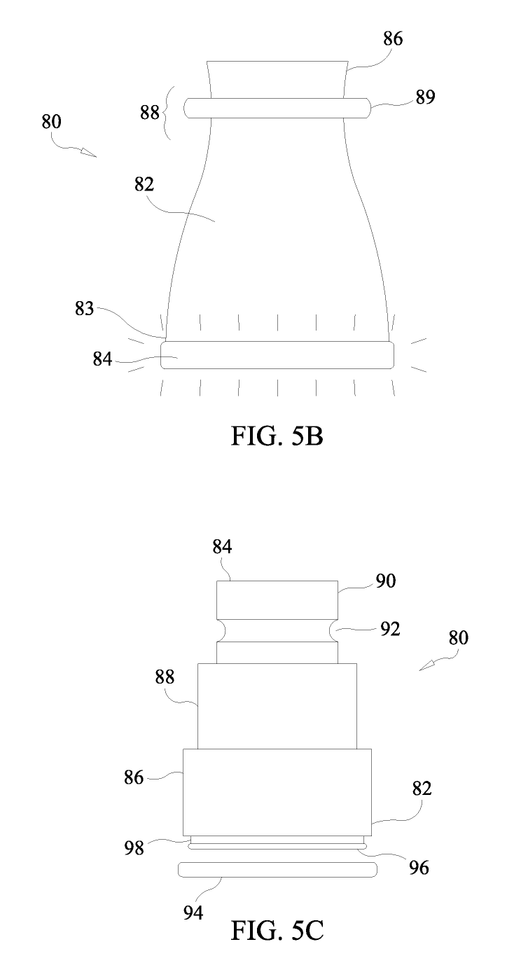

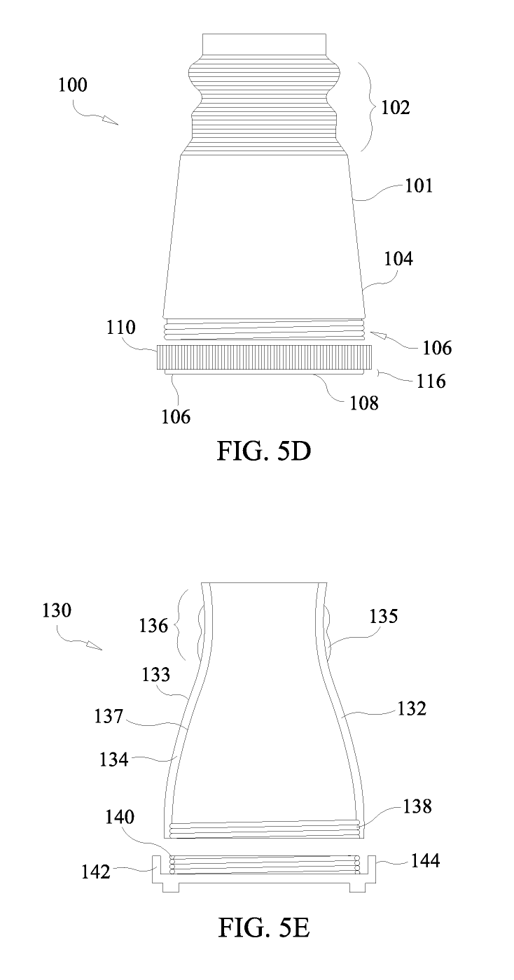

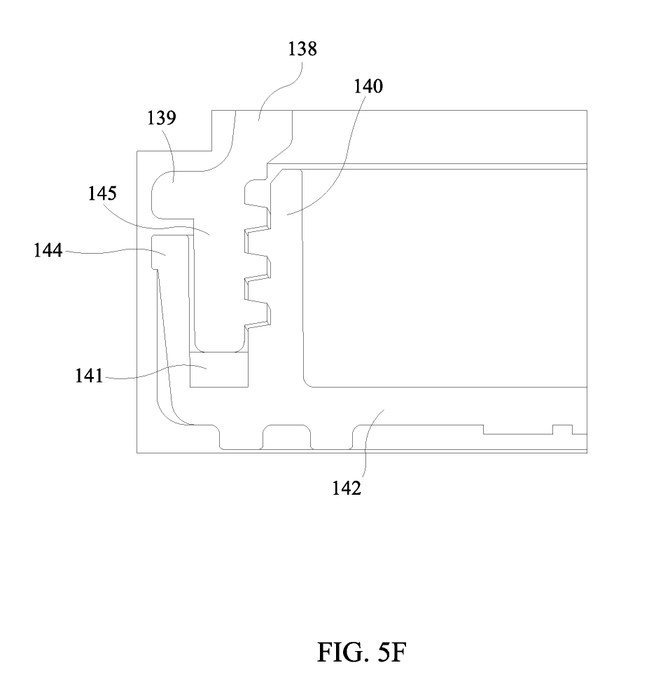

FIG. 5a shows an alternative embodiment of a container 70. Container 70 may have a top 76. Having a lip 77 formed by an annular protrusion about top 76. neck region 78 is substantially cylindrical and extends downward from the top 76. Body 72 may be a convex frustoconical shape, similar to the body 12 shown in FIGS. 1 and 2. The body 72 may extend from the neck region 78 to the bottom 73. A base 75 may be removably attachable to the bottom 73. Container 70 may be slightly smaller than container 10 of FIGS. 1 and 2. Container 70 may include to annular rings 79. In this embodiment, one ring 79 may be located on the neck region 78. While one ring 79 may be located on the body 72, somewhat close to where the body 72 and the neck region 78 meet.

FIG. 5b shows an alternative embodiment of a container 80. Container 80 has a top 86. Neck region 88 may extend from the top 86 to the body 82. Neck region 88 may be substantially cylindrical and may include a single annular ring 89. Body 82 may be frusto-conical, or may be convex frustoconical. Body 82 extends to the bottom 83. Bottom 83 may be removably attachable to base 82. In this embodiment, base 82 may incorporate lighting that may blink or glow in order to add and aesthetic effect. Optionally, one or more bases may be used interchangeably, each providing a different effect. Optionally lighting may be incorporated into the body of the container. Other ornamental features may optionally be included.

FIG. 5c shows an alternative embodiment of a container 80. The bottom 82 is wider than the top 84. In this embodiment, the container 80 may consist of a plurality of cylinders 86, 88, and 90 which may be successively smaller along the height of the container 80. The lower portion 86 is the widest cylinder, middle portion 88 is smaller than lower portion 86 and top portion 90 is smaller than middle portion 88. Top portion 90 may include an annular channel 92 to facilitate gripping. Optionally, top portion 90 may include one or more ribs or a plurality of channels and may optionally include coating to enhance gripping. Base 94 may attach to the bottom 82 by snapping on to groove 96 at the periphery of an annular ring 98 extending downward from the bottom 82 of the container 80.

FIG. 5d shows an alternative embodiment of a container 100 having a frustoconical body 101 which may provide a low center of gravity. A neck region 102 may have a plurality of grooves to enhance gripping. The bottom 104 may have a threaded cuff 106 that extends downward and allows for removable attachment of base 108. Base 108 may have a knurled outside wall 110 that facilitates firmly and securely engaging the base 108 with threaded cuff 106 by screwing the cuff and bases together. The base 108 may include a shoulder 116 at the bottom of the outside wall 110. This may allow base 108 to be nested in series with other bases 108 similar to the bases shown in FIG. 4.

FIG. 5e shows a cross-sectional view of another alternative embodiment of a container 130 with frustoconical body 132 having a neck region 136. The body 132 may be comprised of an outer wall 133 and an inner wall 137, thereby creating a void space 134 that may be filled with air or other insulating material. Neck region 136 may have a grip enhancing rubber ring 135 that is formed separately and affixed to the neck region 136. Rubber ring 135 may be removably or permanently attached. The inside of bottom 138 may be threaded such that it may engage the protruding threaded region 140 of base 142. Base 142 may also have an outer flange 144 that may optionally be threaded and engageable with the outside of bottom 138. Base 142 may be nested with other similar bases to facilitate storage.

FIG. 5f shows an enlarged cross-sectional view of the bottom 138 and base 142 of FIG. 5e. The bottom 138 of container 130 includes an annular flange 139 and cuff 145 having interior threading. The threading of cuff 145 engages with the threading of region 140. Outer flange 144 extends about cuff 145. The base 142 may optionally include an O-ring 141. O-ring 141 may assist in facilitating hermetic sealing between container 130 and base 142.

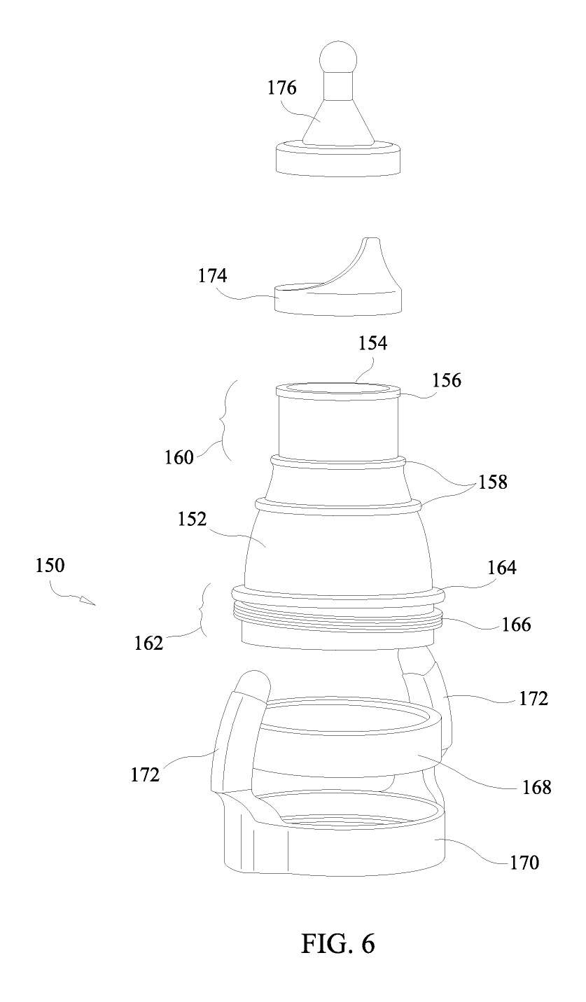

FIG. 6 shows another alternative embodiment of a container 150 that may include multiple components. The container 150 may have a top 154 having a protruding annular lip 156. A neck region, 160 may be substantially cylindrical and extend downward from the top 154. A body 152 may have a convex frustoconical shape. Annular rings 158 may be located on the neck region, 164 on the body 152. In this embodiment, one ring 158 is located on the neck region close to the point where the body 152 intersects the 60. Another annular ring 158 is located near the top of the body 152. The bottom 162 of the container 150 has an annular flange 164 and a downwardly extending threaded cuff 166.

A base 168 may be removably attachable to the bottom 162 of the container 150. The base 168 may include an O-ring or other features. A handle attachment ring 170 may be removably attachable to the base 168. The handle attachment ring 170 may be attachable to the base 168 by any suitable mechanical means, such as for example frictional attachment, threading, tongue and groove, and the like. The handle attachment ring 170 may have one or more upwardly extending handles 172. It may be desirable to provide removable attachment of handles 172 to a container 150 depending upon the age and dexterity of the person using the container 150. Handles may be provided extending upward from the bottom of a container and being a permanent part of the body. However, it may be desirable to include them as part of an optional attachment as shown here. Optionally, the handles may be attached to the top of a container and extend downward.

Container 150 may also include one or more attachments for removable attachment to the top 154. Sippy cup attachment 174 may be removably attached to the top 154. Optionally, sippy cup attachment 174 may snap on to the top 154 by interacting with the lip 156. Nipple attachment 176 may also be removably attached to the top 154, and such attachment may be facilitated by interacting with the lip 156. By providing several attachments, such as handle attachment ring 170, sippy cup attachment 174 and nipple attachment 176, a person may continue using the same familiar container 150 throughout several stages of infancy and childhood.

Whereas, the present invention has been described in relation to the drawings attached hereto, it should be understood that other and further modifications, apart from those shown or suggested herein, may be made within the spirit and scope of this invention. Descriptions of the embodiments shown in the drawings should not be construed as limiting or defining the ordinary and plain meanings of the terms of the claims unless such is explicitly indicated.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

1. A container comprising:
a top;
a neck region;
a body;
a bottom; and,
a base;
wherein the bottom is wider than the top body; and,
wherein the base is removably attachable to the bottom of the body.

2. The container of claim 1 further comprising one or more gripping enhancing features on the exterior of the container selected from the group consisting of ribs, knurled surfaces, channels, grooves, coatings of a material that enhances static friction, and a rubber coating.

3. The container of claim 1 wherein the bottom includes an annular flange.

4. The container of claim 1 wherein the body has a shape selected from the group consisting of frusto-conical, one or more cylindrical sections, and conical prismatic having radial symmetry and a polygonal transverse cross-section.

5. The container of claim 1 wherein the neck region is substantially cylindrical and the body has a convex frusto-conical shape.

6. The container of claim 1 further comprising one or more annular ribs on the neck region.

7. The container of claim 1 wherein the base comprises an outside wall having one or more gripping enhancing features.

8. The container of claim 1 wherein the neck region is sized to fit within the body such that two or more containers may be stackable, with the neck regions nested within the bodies of subsequent containers.

9. The container of claim 1 further comprising a handle attachment ring having a handle.

10. The container of claim 1 further comprising a nipple attachment and a sippy cup attachment.

11. A container comprising:
a top;
a neck region;
a body;
a bottom; and,
a base;
wherein the bottom is wider than the top body;
wherein the base is removably attachable to the bottom of the body; and,
wherein the neck region is sized to fit within the body such that two or more containers may be stackable, with the neck regions nested within the bodies of subsequent containers.

12. The container of claim 11 further comprising one or more gripping enhancing features on the exterior of the container selected from the group consisting of ribs, knurled surfaces, channels, grooves, coatings of a material that enhances static friction, and a rubber coating.

13. The container of claim 11 wherein the bottom includes an annular flange.

14. The container of claim 11 wherein the body has a shape selected from the group consisting of frusto-conical, one or more cylindrical sections, and conical prismatic having radial symmetry and a polygonal transverse cross-section.

15. The container of claim 14 wherein the neck region is substantially cylindrical and the body has a convex frusto-conical shape.

16. The container of claim 11 further comprising one or more annular ribs on the neck region.

17. The container of claim 11 wherein the neck region is sized to fit within the body such that two or more containers may be stackable, with the neck regions nested within the bodies of subsequent containers.

18. The container of claim 11 further comprising a handle attachment ring having a handle, a nipple attachment and a sippy cup attachment.

19. A container comprising:
a top;
a substantially cylindrical neck region;
a body;
four annular ribs on the neck region;
a bottom having an annular flange and a downward extending threaded cuff; and,
a base removably attachable to the threaded cuff of the bottom;
wherein the bottom is wider than the top body; and,
wherein the neck region is sized to fit within the body such that two or more containers may be stackable, with the neck regions nested within the bodies of subsequent containers.

20. The container of claim 19 further comprising a handle attachment ring having a handle, a nipple attachment and a sippy cup attachment.
